(19) United States
(12) Patent Application Publication
(10) Pub. No.: US 2006/0209229 A1
(43) Pub. Date: Sep. 21, 2006

(54) Liquid crystal display with same-sided light guide and IC

(75) Inventors: Ming-Bo Tai, Shenzhen (CN); Che-Kuei Mai, Miao-Li (TW); Yu-Hsun Jen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/384,778

(22) Filed: Mar. 20, 2006

(30) Foreign Application Priority Data
Mar. 18, 2005 (TW) 94204243

(51) Int. Cl. G02F 1/1335

(52) U.S. Cl. 349/63

(57) ABSTRACT

A liquid crystal display (4) includes a first panel (41), a second panel (42) opposite to the first panel, a liquid crystal layer sandwiched between the two panels, a light guide plate (400) and an integrated circuit (IC) (43) facing with each other under the second panel, and a light source (410) disposed on the IC, wherein the light source faces an edge of the light guide plate, and the IC electrically connects directly with the light source. The LCD has a high space utilization ratio and has a compact size. Further, the light source electrically connects directly with the IC, whereby the LCD has been simplified.

### FIELD OF THE INVENTION

The present invention relates to liquid crystal displays (LCDs), and particularly to chip on glass (COG) type LCDs.

### BACKGROUND

Compared with CRTs (cathode ray tubes), LCDs have a number of advantages including a lower driving voltage, lower power consumption, lower radiation, thinness, and lightness (in weight). Thus, LCDs are applied in numerous kinds of video devices and communication devices. A typical LCD includes a driving integrated circuit (IC). Bonding technologies for securing the driving IC in an LCD have developed from earlier chip on board (COB) and tape carrier bonding (TAB) techniques to the more recent COG, chip on film (COF), etc techniques.

Referring to FIGS. 3 and 4, these show parts of interest of a conventional LCD. The LCD 1 includes an upper glass substrate 11, a lower glass substrate 12, a liquid crystal layer (not shown) sandwiched between the substrates 11, 12, a driving IC 13, a flexible printed circuit board (FPC) 14, and a backlight module 19 arranged under the lower glass substrate 12. An anisotropic conductive film (ACF) 17 is arranged between the driving IC 13 and the lower glass substrate 12. The ACF 17 contains electrically conductive particles (not shown) embedded in an insulative compound.

The lower glass substrate 12 has an input wiring pattern 161 and an output wiring pattern 162 formed thereon. The driving IC 13 includes a plurality of aligned first solder bumps 151 overlying an end portion of the input wiring pattern 161, and a plurality of aligned second solder bumps 152 overlying an end portion of the output wiring pattern 162. The driving IC 13 electrically communicates with a plurality of display switching elements (not shown) formed on the lower glass substrate 12 of the LCD 1 by way of the ACF 17 electrically connecting the first solder bumps 151 with the input wiring pattern 161. In addition, the driving IC 13 electrically communicates with the FPC 14 by way of the ACF 17 electrically connecting the second solder bumps 152 with the output wiring pattern 162.

Referring also to FIG. 5, the driving IC 13 electrically communicates with both the switching elements of the LCD 1 and the FPC 14 via mechanical and electrical bonding of the ACF 17 to its respective adjoining components. In particular, a bonding process is performed under pressure and heat during manufacturing and assembly of the LCD 1. Electrical communication between the first solder bumps 151 and the input wiring pattern 161, and between the second solder bumps 152 and the output wiring pattern 162, is only established where the conductive particles in the ACF 17 are compressed. That is, the compression is performed selectively and anisotropically, to achieve the desired corresponding electrical connectivity.

The lower glass substrate 12 of the LCD 1 is normally provided with a larger area than the upper glass substrate 11. Thus the lower glass substrate 12 provides an exposed edge area necessary for mounting of the driving IC 13 and the FPC 14. The need for the edge area means that the overall size of the LCD 1 may be excessively large. Thus the LCD 1 may not be suitable for certain compact applications. In addition, the driving IC 13 is essentially mounted directly on the lower glass substrate 12, whereby the driving IC 13 faces the end of the upper glass substrate 11. However, the driving IC 13 is generally thicker and higher than the upper glass substrate 11, which further increases the overall thickness size of the LCD 1.

What is needed, therefore, is a more compact LCD.

### SUMMARY

In a preferred embodiment, a liquid crystal display includes a first panel, a second panel opposite to the first panel, a liquid crystal layer sandwiched between the two panels, a light guide plate and an integrated circuit (IC) provided at a same side of the second panel, the light guide plate and the IC facing each other, and a light source adjacent to the IC, the light source and the light guide plate cooperatively providing light beams that pass through the second panel, the liquid crystal layer and the first panel.

In another preferred embodiment, a liquid crystal display includes a first panel, a second panel opposite to the first panel, a liquid crystal layer sandwiched between the two panels, a light guide plate and an integrated circuit (IC) under the second panel, and a light source disposed on the IC, wherein the light source faces an edge of the light guide plate, and the integrated circuit electrically connects directly with the light source.

Because the LCDs has set the light source disposed on the IC faces the light guide plate, and the light source and the light guide plate cooperatively provide light beams that pass through the second panel, the liquid crystal layer and the first panel, whereby a space adjacent to the light guide plate and the lower panel is efficiently utilized to receive the IC. Therefore, the LCDs have a high space utilization ratio and a compact size. In addition, the IC electrically connects directly with the light source, whereby there is no needed to provide other elements for electrically connecting the light source with an external power source. Therefore, the structure of the LCD has been simplified.

Other advantages and novel features will become more apparent from the following detailed description when taken in conjunction with the accompanying drawings, in which:

### BRIEF DESCRIPTION OF THE DRAWINGS

FIG. 1 is a schematic, top plan view of part of an LCD according to a first embodiment of the present invention, including part of an FPC thereof;

FIG. 2 is a cross-sectional view taken along line II-II of FIG. 1;

FIG. 3 is schematic, top plan view of part of a conventional LCD manufactured by a conventional COG technique, including part of an FPC thereof;

FIG. 4 is a cross-sectional view taken along line IV-IV of FIG. 3;

FIG. 5 is a cross-sectional view corresponding to line V-V of FIG. 4.

### DETAILED DESCRIPTION OF PREFERRED EMBODIMENTS

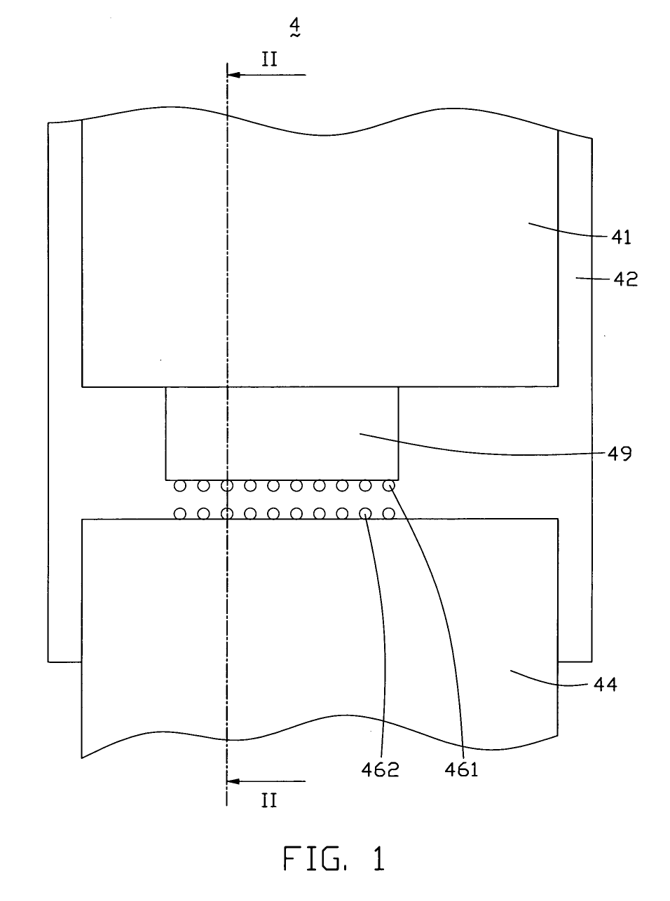

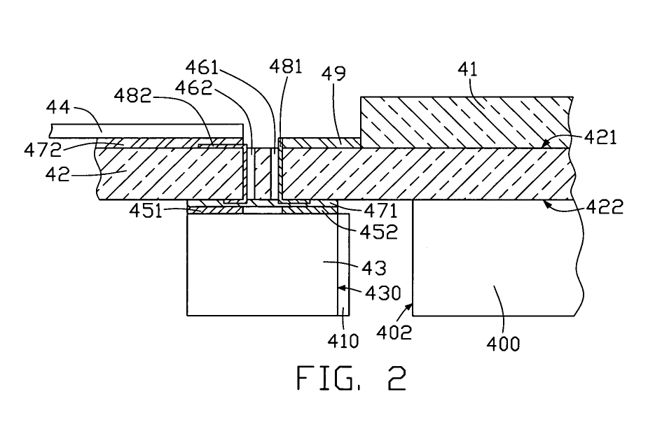

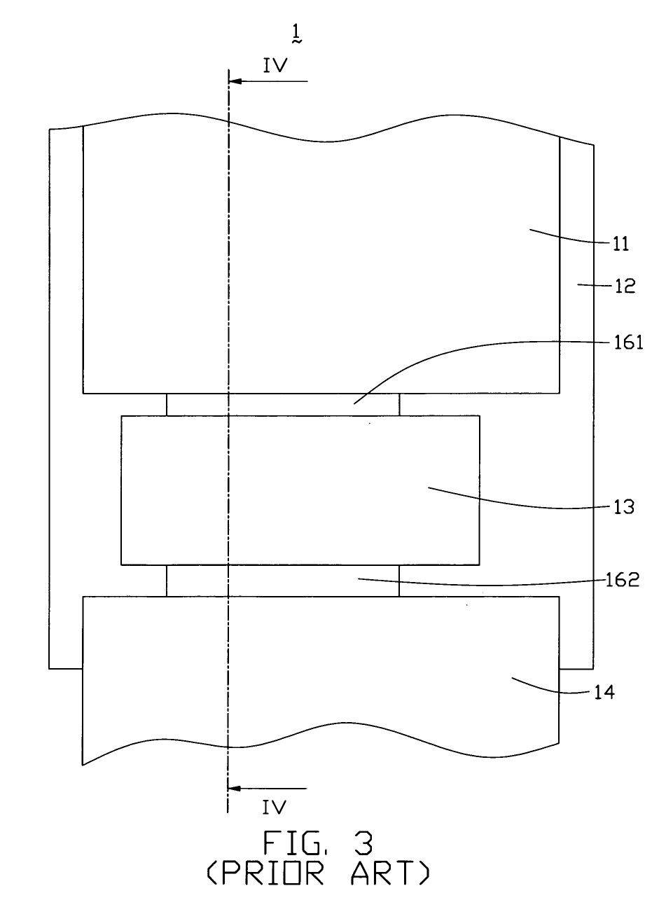

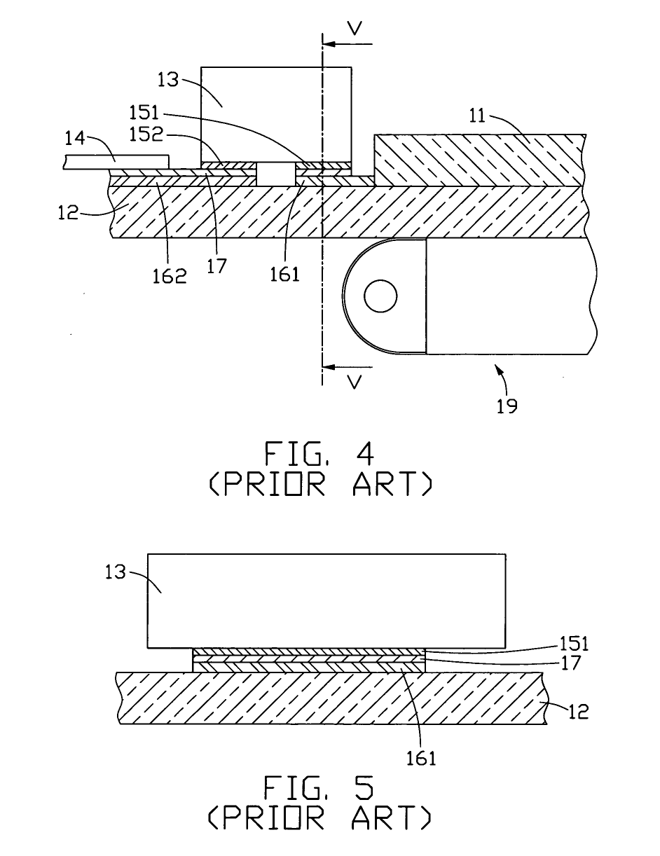

Referring to FIGS. 1-2, an LCD 4 of a first embodiment of the present invention includes an upper panel 41, a lower panel 42, a liquid crystal layer (not shown) having a plurality of liquid crystal molecules, a light guide plate 400 and an IC 43 under the lower panel 42, and an FPC 44 for communicating with external circuits such as those of an external printed circuit board (not shown). The upper panel 41 and the lower panel 42 are spaced apart from each other, and the liquid crystal layer is disposed therebetween. The lower panel 42 has a larger area than the upper panel 41. Thus the lower panel 42 provides an exposed edge area for mounting of the IC 43 and the FPC 44 thereon. The IC 43 is utilized to drive and control the LCD 4.

The lower panel 42 includes: a first surface 421, most of which abuts the upper panel 41; a second surface 422, most of which abuts the light guide plate 400; an input wiring pattern 49 formed on an end portion of the first surface 421, for inputting signals to drive the panels 41, 42; a plurality of aligned first through holes 461 adjacent to one end of the input wiring pattern 49; and a plurality of aligned second through holes 462 adjacent to one end of the FPC 44. The line of second through holes 462 is spaced a short distance from and is parallel to the line of first through hole 461. The lower panel 42 further includes a first guide pattern 481 and a second guide pattern 482. The first guide pattern 481 extends from the second surface 422 through the first through holes 461 to connect with the input wiring pattern 49. The second guide pattern 482 extends from the second surface 422 through the second through holes 462 to the first surface 421.

The light guide plate 400 has a light entrance surface 402 at an edge thereof nearest the IC 43, and the IC 43 has a side surface 430 facing toward the light entrance surface 402. A light source 410 is disposed on the side surface 430, and faces the light entrance surface 402 of the light guide plate 400. The light source 410 may be one or more light emitting diodes (LEDs), which can be formed by depositing suitable semiconductor material on the side surface 430. Further, to simplify the structure of the LCD 4, a driving circuit for the light source 410 can be integrated into the IC 43. That is, it can simplify the LCD 4 that the IC 43 can drive and control the light source 410. The light source 410 and the light guide plate 400 cooperatively provide guided light beams that pass through the lower panel 42, the liquid crystal layer and the upper panel 41 in order to provide displaying of images by the LCD 4.

The IC 43 includes a plurality of first solder bumps 451 disposed corresponding to the first guide pattern 481, and a plurality of second solder bumps 452 disposed corresponding to the second guide pattern 482 and spaced apart from the first solder bumps 451. The first and second solder bumps 451, 452 may be spherical or generally rectangular protrusions. Typically, the first and second solder bumps 451, 452 are plated with gold.

The IC 43 electrically communicates with a plurality of display switching elements (not shown) formed on the lower panel 42 of the LCD 2 via a first portion of the first ACF 471 and the first guide pattern 481. That is, the first portion of the first ACF 471 and the first guide pattern 481 cooperatively electrically connect the first solder bumps 451 of the IC 43 with the input wiring pattern 49 of the lower panel 42. In addition, the IC 43 electrically communicates with the FPC 44 via a second portion of the first ACF 471, the second guide pattern 482, and the second ACF 472. That is, the second portion of the first ACF 471, the second guide pattern 482 and the second ACF 472 cooperatively electrically connect the second solder bumps 452 of the IC 43 with the FPC 44.

The IC 43 electrically communicates with the switching elements of the LCD 4 and with the FPC 44 via mechanical and electrical bonding of the first and second ACFs 471, 472 to their respective adjoining components. In particular, a bonding process is performed under pressure and heat during manufacturing and assembly of the LCD 2. Electrical communication between the first solder bumps 451 and the first guide pattern 481, between the second solder bumps 452 and the second guide pattern 482, and between the second guide pattern 482 and the FPC 44, is only established where conductive particles (not shown) in the respective first and second ACFs 471, 472 are compressed. That is, the compression is performed selectively and anisotropically, to achieve the desired corresponding electrical connectivity.

The manufacturing and assembly process involving bonding of the IC 43 on the lower panel 42 includes the following steps: firstly, adhering the first ACF 471 on the second surface 422 of the lower panel 42, with an edge of the first ACF 471 facing the edge of the light guide plate 400, and the first ACF 471 being positioned corresponding to the first and second through holes 461, 462 and the first and second guide patterns 481, 482; secondly, adhering the second ACF 472 on the first surface 421 of the lower panel 42, with an edge of the second ACF 472 facing toward a nearest edge of the upper panel 41, and the second ACF 472 being positioned corresponding to the second guide pattern 482; thirdly, press-bonding and heating the IC 43 on the first ACF 471, thereby electrically connecting the first solder bumps 451 of the IC chip 43 with the first guide pattern 481, and the second solder bumps 452 of the IC chip 43 with the second guide pattern 482, both connections being attained through corresponding of the conductive particles of the first ACF 471; and finally press-bonding and heating the FPC 44 on the second ACF 472, thereby electrically connecting the FPC 44 with the second guide pattern 482, the connection being attained through corresponding of the conductive particles of the second ACF 472.

In operation, the FPC 44 provides external signals to the IC 43 through the second ACF 472, the second guide pattern 482, the second portion of the first ACF 471, and the second solder bumps 452 of the IC 43. When the IC 43 receives the external signals, the IC 43 sends driving signals to the switching elements of the lower panel 42. The driving signals are sent through the first solder bumps 451, the first portion of the first ACF 471, the first guide pattern 481, and the input wiring pattern 49 of the lower panel 42, and drive the switching elements to respectively turn on or turn off. Thereby the LCD 4 displays corresponding images.

In summary, the LCD 4 has the IC 43 and the light guide plate 400 set on the second surface 422 of the lower substrate 42, with the light source 410 disposed on the IC 43 facing the light guide plate 400. Thereby, a space adjacent to the light guide plate 400 and the lower panel 42 is efficiently utilized. Therefore, the LCD 4 has a high space utilization ratio and a compact size. In addition, the IC 43 drives and controls the light source 410, that is, the IC 43 and the light source 410 electrically connect with each other, whereby there is no need to provide other elements for electrically connecting the light source 410 with an external power source. Therefore, the structure of the LCD 4 is simplified.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display, comprising:
a first panel;
a second panel opposite to the first panel;
a liquid crystal layer sandwiched between the two panels;
a light guide plate and an integrated circuit (IC) provided at a same side of the second panel, the light guide plate and the IC facing each other; and
a light source adjacent to the IC, the light source and the light guide plate cooperatively providing guided light beams that pass through the second panel, the liquid crystal layer and the first panel.

2. The liquid crystal display as claimed in claim 1, wherein the IC is disposed in a space adjacent to the light guide plate and the second panel.

3. The liquid crystal display as claimed in claim 1, wherein the second panel comprises a first surface generally adjacent to the first panel, and a second surface facing toward and/or adjacent to the backlight module and the IC.

4. The liquid crystal display as claimed in claim 3, wherein the second panel further comprises an input wiring pattern formed on the first surface thereof, for inputting of signals to drive the first and/or second panels in order that the liquid crystal display displays images.

5. The liquid crystal display as claimed in claim 4, wherein the second panel further comprises a plurality of first through holes, and a plurality of second through holes spaced apart from the first through holes.

6. The liquid crystal display as claimed in claim 5, wherein the second panel further comprises a first guide pattern formed on the second surface and in the first through holes thereof, the first guide pattern connecting with the input wiring pattern.

7. The liquid crystal display as claimed in claim 6, wherein the first guide pattern extends through the first through holes to connect with the input wiring pattern.

8. The liquid crystal display as claimed in claim 5, wherein the second panel further comprises a second guide pattern formed on the first and the second surfaces and in the second through holes thereof.

9. The liquid crystal display as claimed in claim 8, wherein the second guide pattern extends through the second through holes.

10. The liquid crystal display as claimed in claim 9, wherein the IC chip comprises a plurality of first bumps and a plurality of second bumps.

11. The liquid crystal display as claimed in claim 10, wherein the first bumps are disposed corresponding to the first guide pattern, and the second bumps are disposed corresponding to the second guide pattern.

12. The liquid crystal display as claimed in claim 11, wherein the first bumps electrically connect with the first guide pattern through a first portion of the first anisotropic conductive film (ACF).

13. The liquid crystal display as claimed in claim 12, wherein the second bumps electrically connect with the second guide pattern through a second portion of the first ACF.

14. The liquid crystal display as claimed in claim 13, further comprising a flexible printed circuit (FPC), wherein the second guide pattern electrically connects with the FPC through a second ACF.

15. The liquid crystal display as claimed in claim 1, wherein the light source is formed by depositing a layer of semiconductor material on the IC.

16. A liquid crystal display, comprising:
a first panel;
a second panel opposite to the first panel;
a liquid crystal layer sandwiched between the two panels; and
a light guide plate, a light source and an integrated circuit (IC) located on a same side of the second panel and commonly opposite to said first panel, the light guide plate and the IC facing each other.

17. A liquid crystal display, comprising:
a first panel;
a second panel opposite to the first panel;
a liquid crystal layer sandwiched between the two panels;
a light guide plate and an integrated circuit (IC) under the second panel; and
a light source disposed on the IC;
wherein the light source faces an edge of the light guide plate, and the integrated circuit electrically connects directly with the light source.

18. The liquid crystal display as claimed in claim 17, wherein the IC is disposed in a space adjacent to the light guide plate and the second panel.

19. The liquid crystal display as claimed in claim 17, wherein the light source is at least one light emitting diode (LED).

20. The liquid crystal display as claimed in claim 17, wherein the light source is formed by depositing a layer of semiconductor material on the IC.
